(19) United States
(12) Patent Application Publication
(10) Pub. No.: US 2018/0281206 A1
(43) Pub. Date: Oct. 4, 2018

(54) ROBOT ARM MECHANISM

(71) Applicant: LIFE ROBOTICS INC., Tokyo (JP)

(72) Inventors: Woo-Keun YOON, Tokyo (JP); Hiroaki Matsuda, Tokyo (JP)

(21) Appl. No.: 16/001,999

(22) Filed: Jun. 7, 2018

Related U.S. Application Data
(63) Continuation of application No. PCT/JP2016/085586, filed on Nov. 30, 2016.

(30) Foreign Application Priority Data
Dec. 12, 2015 (JP) 2015-242751

(51) Int. Cl. B25J 17/02; B25J 18/00; F16H 21/44

(52) U.S. Cl. CPC B25J 17/0258; B25J 18/00; F16H 7/023; Y10S 901/28; F16H 21/44

(57) ABSTRACT

A robot arm mechanism includes first and second parallel link mechanisms connected in cascade. A first drive motor used to drive the first parallel link mechanism is installed in an upper part of a column. A second drive motor used to drive the second parallel link mechanism is also installed in the upper part of the column. Rotation of the second drive motor is transmitted to the second parallel link mechanism via a transmission mechanism. The transmission mechanism includes a first pulley pivotally supported coaxially with a pivot shaft at a rear end of a first link, a second pulley pivotally supported coaxially with a pivot shaft at a front end of the first link, and a transmission belt looped over the first and second pulleys.

### CROSS-REFERENCE TO RELATED APPLICATIONS

This application is a continuation application of International Patent Application No. PCT/JP2016/085586 filed on Nov. 30, 2016, which is based upon and claims the benefit of priority from the prior Japanese Patent Application No. 2015-242751, filed Dec. 12, 2015, the entire contents of which are incorporated herein by reference.

### TECHNICAL FIELD

Embodiments of the present invention relate to a robot arm mechanism.

### BACKGROUND ART

In recent years, environments in which a robot exists in the same space as a user have been increasing. Presumably situations in which not only a nursing care robot, but also an industrial robot is working side by side with an operator will be expanding. Many of such robots are equipped with an articulated arm mechanism. Articulated arm mechanisms require three degrees of positional freedom (x, y, z) and three degrees of freedom (φ, θ, ψ) in terms of posture. Generally, the degrees of freedom are implemented by rotational joints J1, J2, and J3 called root three axes, and rotational joints J4, J5, and J6 called wrist three axes. Rotation is implemented by a first joint J1 placed on a base (column) and back-and-forth motion and up-and-down motion of a hand are implemented by coordination of the rotational joints J2 and J3 whose axes of rotation are placed horizontally.

In recent years, an arm mechanism made up of two parallel link mechanisms connected together in cascade has appeared in place of the joints J2 and J3. Motion of an upper arm is implemented by the parallel link mechanism on the base side and motion of a forearm is implemented by the parallel link mechanism on the hand side. By mounting a drive motor for the parallel link mechanism of the upper arm on the base, and a drive motor for the parallel link mechanism of the forearm on a connecting part, and thereby making the motions of the parallel link mechanisms independent of each other, degrees of freedom of motion are increased.

It is assumed that in the future, there will be growing demand for task time reduction and increases in the speed of joints for that purpose. In order for the above-mentioned robot arm mechanism made up of two parallel link mechanisms connected in cascade to keep up with the demand, higher-torque motors are required. Then, increases in the weight of the high-torque motors demand higher rigidity from the linkages, which increases the weight of the linkages. The weight increases demand higher-torque motors. In this way, to meet the demand for speed increases, it is inevitable to increase the weight of the entire robot arm mechanism and increase the motor torque.

### SUMMARY OF INVENTION

### Technical Problem

A purpose of the present invention is to realize speed increases of a robot arm mechanism made up of plural parallel link mechanisms connected in cascade while keeping down weight increases.

### Solution to Problem

A robot arm mechanism according to an embodiment of the present invention comprises: a first arm pivotally supported at a rear end on a stationary part and pivotally supported at a front end on a connecting part; a first link constituting a first parallel link mechanism with the first arm; a second arm pivotally supported at a rear end on the connecting part and pivotally supported at a front end on a movable part fittable with an end effector; and a second link constituting a second parallel link mechanism with the second arm. A first drive motor used to drive the first arm is installed on the stationary part or on a base on which the stationary part is placed. A second drive motor used to drive the second arm is also installed on the stationary part or the base and rotation of the second drive motor is transmitted to the second arm via a transmission mechanism. The transmission mechanism includes a first pulley pivotally supported coaxially with a pivot shaft at a rear end of the first link, a second pulley pivotally supported coaxially with a pivot shaft at a front end of the first link, and a first transmission belt looped over the first and second pulleys.

### BRIEF DESCRIPTION OF DRAWINGS

FIG. 1 is a perspective view illustrating an external appearance of a robot arm mechanism according to an embodiment of the present invention.

FIG. 2 is a diagram illustrating an internal structure of the robot arm mechanism of FIG. 1.

FIG. 3 is a diagram illustrating an up-and-down pivot action carried out by an upper arm of the robot arm mechanism of FIG. 2.

FIG. 4 is a diagram illustrating an up-and-down pivot action carried out by a forearm of the robot arm mechanism of FIG. 2.

FIG. 5 is a diagram illustrating a variation of the internal structure of the robot arm mechanism of FIG. 1.

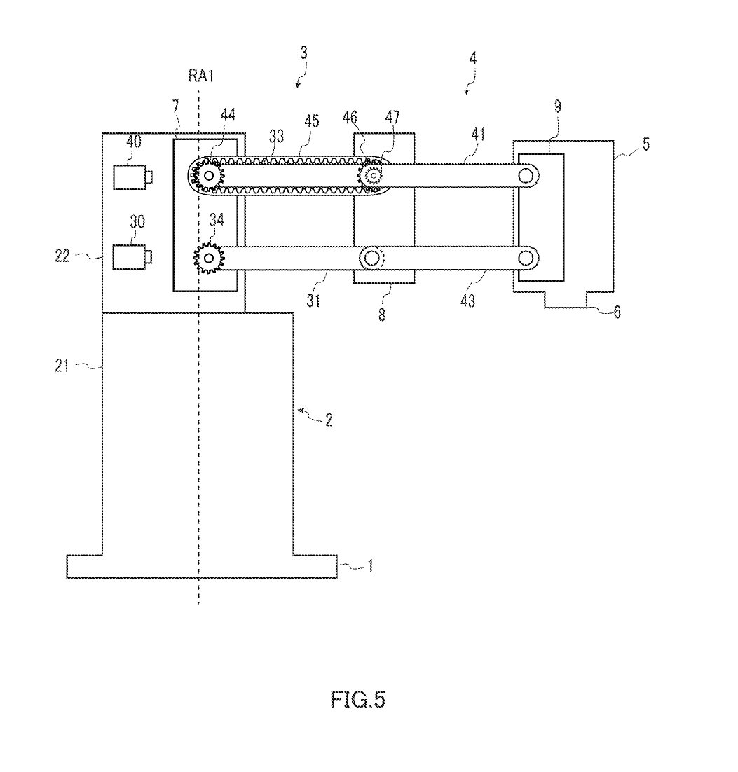

FIG. 6 is a diagram illustrating another variation of the internal structure of the robot arm mechanism of FIG. 1.

FIG. 7 is a diagram illustrating still another variation of the internal structure of the robot arm mechanism of FIG. 1.

FIG. 8 is a diagram illustrating yet still another variation of the internal structure of the robot arm mechanism of FIG. 1.

### DESCRIPTION OF EMBODIMENT

A robot arm mechanism according to an embodiment of the present invention is described below with reference to the drawings. The robot arm mechanism is described by taking a vertical articulated robot arm mechanism as an example. In the following description, components having substantially the same functions and configurations are denoted by the same reference numerals, and redundant description thereof will be omitted unless necessary.

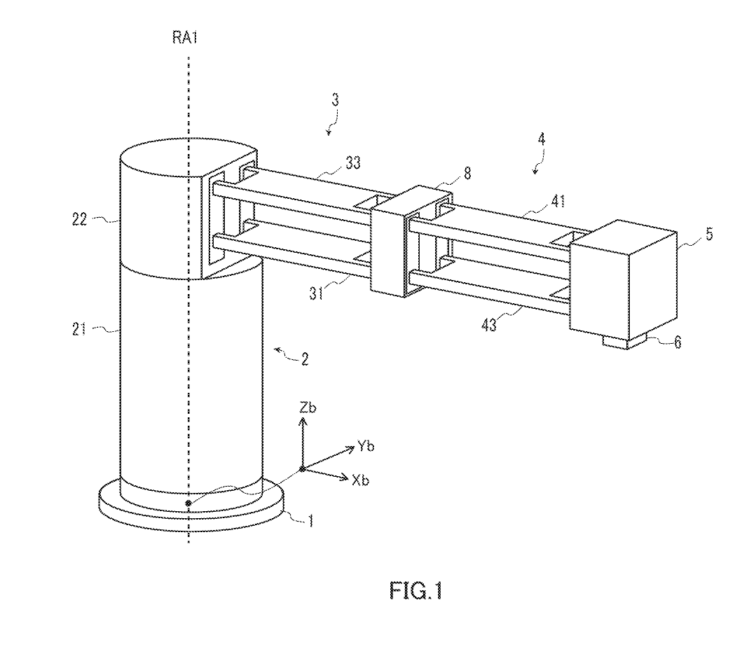

FIG. 1 is an external perspective view of the robot arm mechanism according to the present embodiment. The robot arm mechanism includes a base stand 1, a base (column) 2 columnar in shape and installed on the base stand 1, an upper arm section 3, a forearm section 4, and a wrist section 5. The upper arm section 3, forearm section 4, and wrist section 5 are disposed in order from the column 2. A rear end portion of the upper arm section 3 is connected to a stationary base 7 of the column 2. A front end portion of the upper arm section 3 is connected to a connecting base 8. A rear end portion of the forearm section 4 is connected to the connecting base 8. A front end portion of the forearm section is connected to a movable base 9 of the wrist section 5. The wrist section 5 is provided with a mount 6. The mount 6 is fitted with an end effector (not shown).

The column 2 equips a rotational joint. The rotational joint includes an axis of rotation RA1 parallel to a vertical direction. A robot coordinate system Σb has an origin at an arbitrary position on the axis of rotation RA1 of the rotational joint. Three orthogonal axes (Xb, Yb, Zb) are defined in a robot coordinate system Σb. The Zb axis is parallel to the axis of rotation RA1. The Xb axis and Yb axis are orthogonal to each other and to the Zb axis. The column 2 is made up of a lower part 21 and an upper part 22. A frame of the lower part 21 is installed on the base stand 1. A stationary part of the rotational joint is attached to the frame of the lower part 21. The upper part 22 is connected to a rotating part of the rotational joint. Along with rotation of the rotational joint, the rotating part rotates relative to the stationary part, and consequently the upper arm section 3 rotates around the axis of rotation RA1 together with the part forward of the upper arm section 3. The stationary base 7 is fixed to an inner space of the column 2 that forms a cylindrical body. One end of the upper arm section 3 is rotatably connected to the stationary base 7. Another end of the upper arm section 3 is rotatably connected to the connecting base 8. One end of the forearm section 4 is rotatably connected to the connecting base 8. Another end of the forearm section 4 is rotatably connected to the movable base 9. The movable base 9 is housed in the wrist section 5.

Each of the upper arm section 3 and forearm section 4 are provided as a parallel link mechanism. The two parallel link mechanisms are connected in cascade via the connecting base 8. Note that of two or more rods constituting a parallel link mechanism, a driving rod and a driven rod are distinguished from each other herein by calling the former as an arm and the latter as a link.

The upper arm section 3 includes a first arm 31. The first arm 31 is, for example, a plate-like body whose front and rear end parts are bifurcated. A rear end portion of the first arm 31 is pivotally supported on the stationary base 7 fixed to the upper part 22 of the column 2. A front end portion of the first arm 31 is pivotally supported on the connecting base 8. The first arm 31 makes up a first parallel link mechanism with a first link 33. The first link 33 is, for example, a plate-like body identical to the first arm 31. Typically; the first link 33 is equal in length to the first arm 31. A rear end portion of the first link 33 is pivotally supported on the stationary base 7. On two axes orthogonal to the axis of rotation RA1, the rear end portion of the first link 33 is pivotally supported at the same positions as is the first arm 31. Here the rear end portion of the first link 33 is pivotally supported at a position above the position at which the first arm 31 is pivotally supported. A front end portion of the first link 33 is pivotally supported on the connecting base 8. A front end portion of the first link 33 is pivotally supported at a position a predetermined distance away from a position at which the front end portion of the first arm 31 is pivotally supported. Typically; the distance from the position at which the front end portion of the first link 33 is pivotally supported to a position at which the front end portion of the first arm 31 is pivotally supported is equal to a distance from a position at which the rear end portion of the first arm 31 is pivotally supported to the position at which the rear end portion of the first link 33 is pivotally supported. Furthermore, a distance between a front and rear pivot shafts of the first link 33 is typically equal to a distance between a front and rear pivot shafts of the first arm 31. The first link 33 is placed parallel to the first arm 31. In a horizontal reference posture, the first parallel link mechanism made up of the first link 33, first arm 31, and the like has a rectangular shape.

The forearm section 4 has a second arm 41. The second arm 41 is, for example, a plate-like body whose front and rear end parts are bifurcated. A rear end portion of the second arm 41 is pivotally supported on the connecting base 8. A front end portion of the second arm 41 is pivotally supported on the movable base 9. The second arm 41 makes up a second parallel link mechanism with a second link 43. The second link 43 is, for example, a plate-like body identical to the second arm 41. Typically, the second link 43 is equal in length to the second arm 41. A rear end portion of the second link 43 is pivotally supported on the connecting base 8. On two axes orthogonal to the axis of rotation RA1, the rear end portion of the second link 43 is pivotally supported at the same positions as is the second arm 41. Here, the rear end portion of the second link 43 is pivotally supported at a position below the position at which the second arm 41 is pivotally supported. A front end portion of the second link 43 is pivotally supported on the movable base 9. A front end portion of the second link 43 is pivotally supported at a position a predetermined distance away from a position at which the front end portion of the second arm 41 is pivotally supported. Typically, the distance from the position at which the front end portion of the second link 43 is pivotally supported to a position at which the front end portion of the second arm 41 is pivotally supported is equal to a distance from a position at which the rear end portion of the second arm 41 is pivotally supported to the position at which the rear end portion of the second link 43 is pivotally supported. Furthermore, a distance between a front and rear pivot shafts of the second link 43 is typically equal to a distance between a front and rear pivot shafts of the second arm 41. Consequently, the second link 43 is placed parallel to the second arm 41. In a horizontal reference posture, the second parallel link mechanism made up of the second link 43, second arm 41, and the like has a rectangular shape.

Note that whereas in the above description, the first arm 31 of the first parallel link mechanism is placed above and the first link 33 is placed below, this is not restrictive, and the first arm 31 may be placed below with the first link 33 placed above. Similarly, whereas in the above description, the second arm 41 of the second parallel link mechanism is placed above and the second link 43 is placed below, this is not restrictive, and the second arm 41 may be placed below with the second link 43 placed above in accordance with the arrangement of the first parallel link mechanism.

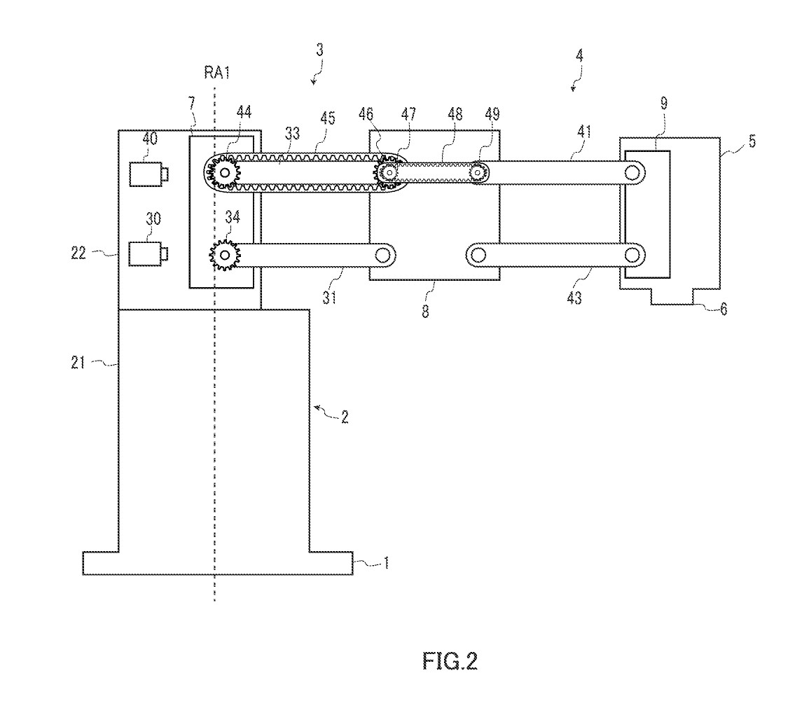

As shown in FIG. 2, a front end pivot shaft of the first arm 31 of the first parallel link mechanism, a front end pivot shaft of the first link 33, a rear end pivot shaft of the second arm 41 of the second parallel link mechanism, and a rear end pivot shaft of the second link 43 are disposed on the connecting base 8 in such a way as to form a rectangular positional relationship.

A first drive motor 30 used to drive the first arm 31 of the first parallel link mechanism, in particular, and a second drive motor 40 used to drive the second arm 41 of the second parallel link mechanism, in particular, are placed on the stationary base 7 or on the upper part. 22 of the column 2 serving as a base on which the stationary base 7 is placed. A drive shaft of the first drive motor 30 is connected to a rotating shaft at a rear end of the first arm 31 either directly or via a speed reducer mechanism. By placing the second drive motor 40 used to drive the second arm 41 of the second parallel link mechanism not on the connecting base 8, but on the stationary base 7 or on the upper part 22 of the column 2 serving as a base on which the stationary base 7 is placed and transmitting rotation of the second drive motor 40 to a rotating shaft at a rear end of the second arm 41 of the second parallel link mechanism, it is possible to realize speed increases of a robot arm mechanism made up of plural parallel link mechanisms connected in cascade while keeping down weight increases.

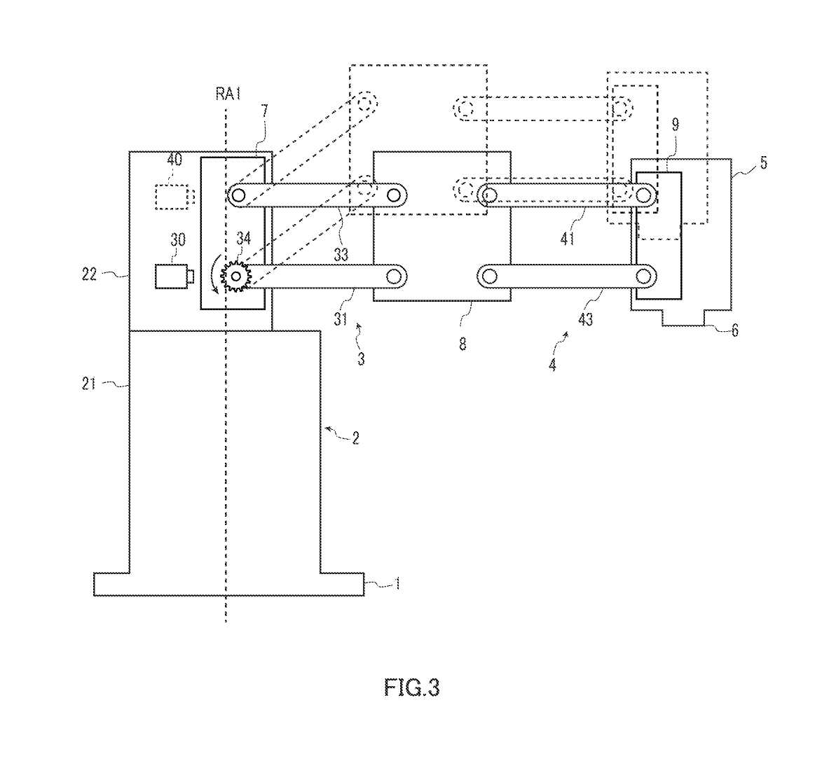

A drive gear 34 is firmly fixed to the rotating shaft at the rear end of the first arm 31 or to the rear end of the first arm 31. A rotating shaft of the drive gear 34 is coaxial with the rotating shaft in the rear end portion of the first arm 31. The drive gear 34 is connected to an output shaft of the first drive motor 30 via the speed reducer mechanism. As shown in FIG. 3, when the first drive motor 30 operates and the drive gear 34 rotates forward or backward, the upper arm section 3 pivots up and down. Consequently, the wrist section 5 is translated.

A third driven pulley 49 is firmly fixed to the rotating shaft in the rear end portion of the second arm 41 of the second parallel link mechanism constituting the forearm section 4 or to the rear end of the second arm 41. A rotating shaft of the third driven pulley 49 is coaxial with the rotating shaft in the rear end portion of the second arm 41. The third driven pulley 49 is connected to an output shaft of the second drive motor 40 via the transmission mechanism.

The transmission mechanism includes a drive pulley 44 (first pulley 44). The drive pulley 44 is connected to the output shaft of the second drive motor 40 via the speed reducer mechanism. The drive pulley 44 is installed coaxially with, and freely rotatably around, a rotating shaft in the rear end portion of the first link 33. A second driven pulley 47 is installed coaxially with, and freely rotatably around, a rotating shaft in the front end portion of the first link 33. An endless flat belt 45 is looped with constant tension between the drive pulley 44 and first driven pulley 46 (second pulley 46). Typically, the first driven pulley 46 is equal in diameter to the drive pulley 44. A speed reduction ratio may be provided by making the first driven pulley 46 smaller in diameter than the drive pulley 44. Also, the flat belt 45 may be replaced with a toothed belt and the pulleys 44 and 46 may be replaced with toothed pulleys.

As a transmission mechanism between the drive pulley 44 and first driven pulley 46, a belt mechanism is used suitably here from the perspective of reducing vibration and noise. However, the present invention is not limited to the belt mechanism, and a wrapping transmission mechanism may be adopted as another rotation transmission mechanism equipped with a flexible torus, such as a wire rope or chain, resistant to tensile forces. The drive pulley 44 and first driven pulley 46 are also replaced with another type in accordance with another type of flexible torus. For example, if a chain is adopted in place of the belt, the pulleys are replaced with sprockets.

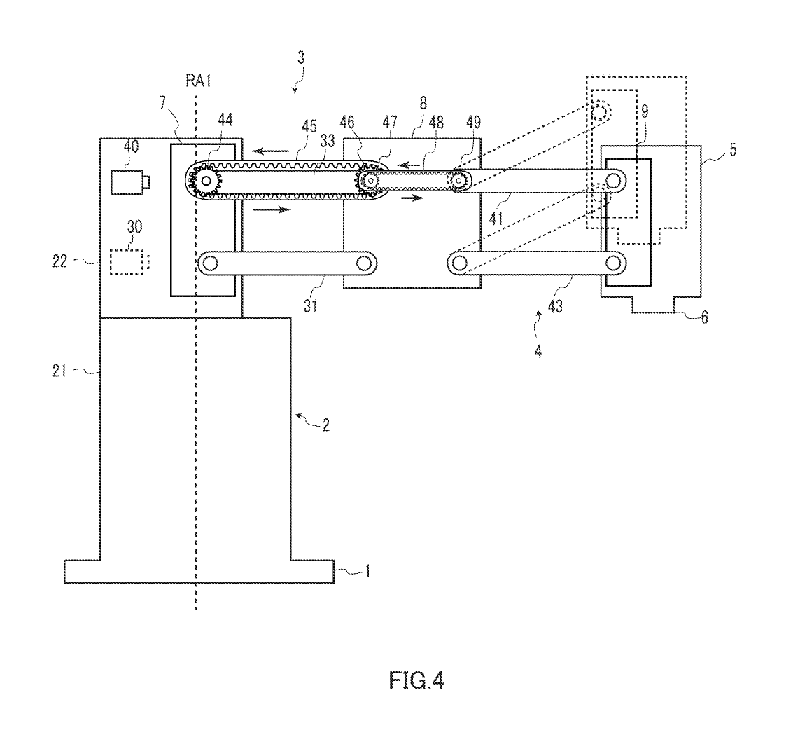

The second driven pulley 47 is firmly fixed to the first driven pulley 46 coaxially with the first driven pulley 46. When the first driven pulley 46 rotates, the second driven pulley 47 rotates by the same angle by following the first driven pulley 46. An endless flat belt 48 is looped with constant tension between the second driven pulley 47 and the third driven pulley 49 in the rear end portion of the second arm 41. Typically, the pulley 49 is equal in diameter to the pulley 47. A speed reduction ratio may be provided by making the pulley 49 smaller in diameter than the pulley 47. Also, the flat belt 48 may be replaced with a toothed belt and the pulleys 47 and 49 may be replaced with toothed pulleys. The drive pulley 44, flat belt 45, first driven pulley 46, second driven pulley 47, flat belt 48, and third driven pulley 49 make up a transmission mechanism used to transmit rotation of the second drive motor 40 to the second arm 41. As shown in FIG. 4, when the second drive motor 40 operates and the rotation is transmitted to the second arm 41 via the transmission mechanism, the forearm section 4 pivots up and down. Consequently, the wrist section 5 is translated. Note that because the second driven pulley 47 and third driven pulley 49 are located relatively close to each other and a positional relationship between the pulleys 47 and 49 remains unchanged, transmission between the two pulleys is not limited to the belt mechanism, and the belt mechanism may be replaced with a gear mechanism.

According to the present embodiment, the above-mentioned transmission mechanism allows the motor 40 used to drive the second parallel link mechanism connected in cascade to the first parallel link mechanism to be placed on the column 2 together with the motor 30 used to drive the first parallel link mechanism rather than on the connecting base 8 adapted to couple together the first and second parallel link mechanisms. This makes it possible to reduce the weight of the connecting base 8 and first parallel link mechanism and achieve increases in the operation speed of the first parallel link mechanism without increasing the torque of the motor 30. Furthermore, since the motor 40 that is heavy in weight can be placed on the column 2, axial rotation (RA1) of the upper part 22 of the column 2 can be speeded up due to decreased moment.

Furthermore, according to the present embodiment since the pulleys 44 and 46 provided on the transmission mechanism used to transmit the rotation of the second drive motor 40 to the second arm 41 of the second parallel link mechanism are pivotally supported coaxially with, and freely rotatably around, the front and rear rotating shafts of the first arm 31 of the first parallel link mechanism, the rotation of the second drive motor 40 installed on the stationary base 7 can be transmitted to the second arm 41 without affecting up-and-down pivot motion of the first arm 31 of the first parallel link mechanism and without the second parallel link mechanism being affected by the up-and-down pivot motion of the first arm 31 of the first parallel link mechanism.

### Variation 1

In the above description, the rear end portion of the second arm 41 of the second parallel link mechanism is pivotally supported at a position different from the front end portion of the first link 33 of the first parallel link mechanism. Similarly, the rear end portion of the second link 43 of the second parallel link mechanism is pivotally supported at a position different from the front end portion of the first arm 31 of the first parallel link mechanism. However, the rear end portion of the second arm 41 of the second parallel link mechanism may be pivotally supported at the same position as the front end portion of the first link 33 of the first parallel link mechanism, and the rear end portion of the second link 43 of the second parallel link mechanism may be pivotally supported at the same position as the front end portion of the first arm 31 of the first parallel link mechanism. In other words, the rear end portion of the second arm 41 of the second parallel link mechanism may share a rotating shaft with the front end portion of the first link 33 of the first parallel link mechanism, and the rear end portion of the second link 43 of the second parallel link mechanism may share a rotating shaft with the front end portion of the first arm 31 of the first parallel link mechanism. In this case, the flat belt 48 and third driven pulley 49 are unnecessary. The rear end portion of the second arm 41 is firmly fixed to the second driven pulley 47. Alternatively, the second driven pulley 47 also becomes unnecessary, and the rear end portion of the second arm 41 is firmly fixed to the first driven pulley 46.

(Variation 2)

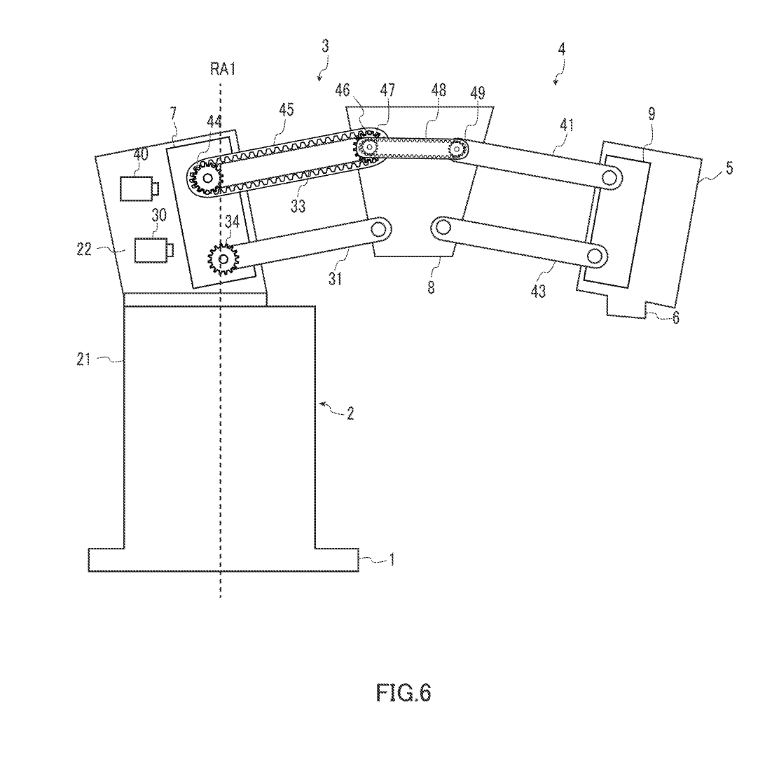

In the above description, the front end pivot shaft of the first arm 31 of the first parallel link mechanism, the front end pivot shaft of the first link 33, the rear end pivot shaft of the second arm 41 of the second parallel link mechanism, and the rear end pivot shaft of the second link 43 are disposed on the connecting base 8 in such a way as to form a rectangular positional relationship, but this is not restrictive. As shown in FIG. 6, the front end pivot shaft of the first arm 31 of the first parallel link mechanism, the front end pivot shaft of the first link 33, the rear end pivot shaft of the second arm 41 of the second parallel link mechanism, and the rear end pivot shaft of the second link 43 may be disposed on the connecting base 8 in such a way as to form a trapezoidal positional relationship. The trapezoid is typically an isosceles trapezoid, but may be a non-isosceles trapezoid or right angle trapezoid. Also, preferably a lower side connecting the front end pivot shaft of the first arm 31 and rear end pivot shaft of the second link 43 is longer than an upper side connecting the front end pivot shaft of the first link 33 and rear end pivot shaft of the second arm 41, but this is not restrictive, and the lower side may be shorter than the upper side.

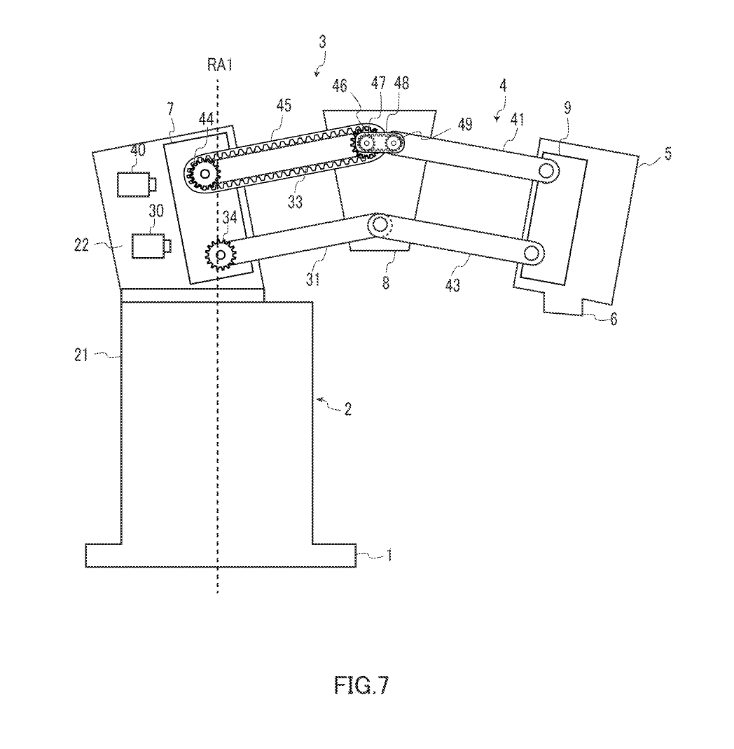

Also, as shown in FIG. 7, the rear end portion of the second arm 41 of the second parallel link mechanism and the front end portion of the first link 33 of the first parallel link mechanism may be pivotally supported at different positions on the connecting base 8, and the rear end portion of the second link 43 of the second parallel link mechanism may share a rotating shaft with the front end portion of the first arm 31 of the first parallel link mechanism. Note that the front end portion of the first arm 31 of the first parallel link mechanism and the rear end portion of the second link 43 of the second parallel link mechanism may be pivotally supported at different positions on the connecting base 8, with the rear end portion of the second arm 41 of the second parallel link mechanism sharing a rotating shaft with the front end portion of the first link 33 of the first parallel link mechanism.

(Variation 3)

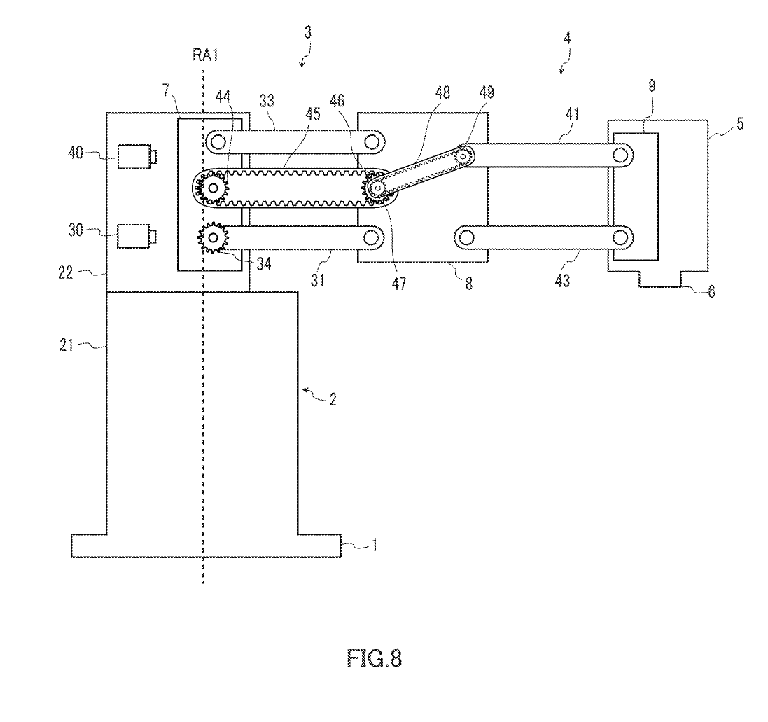

In the above description, the drive pulley 44 and first driven pulley 46 constituting the transmission mechanism are provided coaxially with the rotating shafts in the rear end portion and front end portion of the first link 33 of the first parallel link mechanism, restrictively. However, as shown in FIG. 8, the drive pulley 44 and first driven pulley 46 constituting the transmission mechanism may be provided at positions different from the rotating shafts in the rear end portion and front end portion of the first link 33 of the first parallel link mechanism rather than coaxially therewith, restrictively. In that case, a line connecting the rotating shaft of the drive pulley 44 and rotating shaft of the first driven pulley 46 is parallel to center lines of the arm 31 and the link 33 and the drive pulley 44 and first driven pulley 46 are pivotally supported at such positions that a distance between the rotating shaft of the drive pulley 44 and rotating shaft of the first driven pulley 46 will be equivalent to a distance between the rotating shafts of the arm 31 and link 33.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

### REFERENCE SIGNS LIST

1 . . . base stand, 2 . . . column, 21 . . . lower part, 22 . . . upper part, 3 . . . upper arm section, 30 . . . first drive motor, 31 . . . first arm, 33 . . . first link. 34 . . . drive gear, 4 . . . forearm section, 40 . . . second drive motor, 41 . . . second arm, 43 . . . second link, 44 . . . drive pulley, 45 . . . flat belt, 46 . . . first driven pulley. 47 . . . second driven pulley, 48 . . . flat belt, 49 . . . third driven pulley, 5 . . . wrist section, 6 . . . mount, 7 . . . stationary base, 8 . . . connecting base, 9 . . . movable base.

1. A robot arm mechanism comprising:
a first arm pivotally supported at a rear end on a stationary part and pivotally supported at a front end on a connecting part;
a first link constituting a first parallel link mechanism with the first arm;
a second arm pivotally supported at a rear end on the connecting part and pivotally supported at a front end on a movable part fittable with an end effector;
a second link constituting a second parallel link mechanism with the second arm;
a first drive motor driving the first arm; and
a second drive motor driving the second arm,
wherein the first drive motor is installed on the stationary part or on a base on which the stationary part is placed,
the second drive motor is installed on the stationary part or the base,
rotation of the second drive motor is transmitted to the second arm via a transmission mechanism, and
the transmission mechanism includes a first pulley pivotally supported coaxially with a pivot shaft at a rear end of the first link, a second pulley pivotally supported coaxially with a pivot shaft at a front end of the first link, and a first transmission belt looped over the first and second pulleys.

2. The robot arm mechanism according to claim 1, wherein:
in the connecting part, a pivot shaft at a rear end of the second arm is located diagonally with respect to a pivot shaft at a front end of the first arm, and a pivot shaft at a rear end of the second link is located diagonally with respect to the pivot shaft at the front end of the first link; and
the transmission mechanism further includes a third pulley pivotally supported coaxially with the second pulley in the connecting part and adapted to follow the second pulley, a fourth pulley connected to the rear end of the second arm in the connecting part, and a second transmission belt looped over the third and fourth pulleys.

3. The robot arm mechanism according to claim 1, wherein in the connecting part, a pivot shaft at a front end of the first arm, a pivot shaft at a rear end of the second link, the pivot shaft at the front end of the first link, and a pivot shaft at a rear end of the second arm have such a positional relationship as to be at four vertices of a trapezoid.

4. The robot arm mechanism according to claim 1, wherein the front end of the first link and a rear end of the second arm are pivotally supported coaxially in the connecting part.

5. The robot arm mechanism according to claim 1, wherein in the connecting part, a rear end of the second link is pivotally supported coaxially with a pivot shaft at a front end of the first arm and a rear end of the second arm is pivotally supported coaxially with the pivot shaft at the front end of the first link.

6. A robot arm mechanism comprising:
a first arm pivotally supported at a rear end on a stationary part and pivotally supported at a front end on a connecting part;
a first link constituting a first parallel link mechanism with the first arm;
a second arm pivotally supported at a rear end on the connecting part and pivotally supported at a front end on a movable part fittable with an end effector;
a second link constituting a second parallel link mechanism with the second arm;
a first drive motor used to drive the first arm; and
a second drive motor used to drive the second arm,
wherein the first drive motor is installed on the stationary part or on a base on which the stationary part is placed,
the second drive motor is installed on the stationary part or the base,
rotation of the second drive motor is transmitted to the second arm via a transmission mechanism, and
the transmission mechanism includes a first pulley installed on the stationary part, a second pulley installed on the connecting part, and a transmission belt looped between the first and second pulleys, and the transmission belt is parallel to the first arm.

7. A robot arm mechanism comprising:
a first arm pivotally supported at a rear end on a stationary part and pivotally supported at a front end on a connecting part;
a first link constituting a first parallel link mechanism with the first arm;
a second arm pivotally supported at a rear end on the connecting part and pivotally supported at a front end on a movable part fittable with an end effector;
a second link constituting a second parallel link mechanism with the second arm;
a first drive motor used to drive the first arm; and
a second drive motor used to drive the second arm,
wherein the first drive motor is installed on the stationary part or on a base on which the stationary part is placed,
the second drive motor is installed on the stationary part or the base, and
rotation of the second drive motor is transmitted to the second arm via a wrapping transmission mechanism.
